(19) United States
(12) Patent Application Publication
(10) Pub. No.: US 2018/0119798 A1
(43) Pub. Date: May 3, 2018

(54) Integrated Kickdown

(71) Applicant: Deere & Company, Moline, IL (US)

(72) Inventors: Giovanni A. Wuisan, Dubuque, IA (US); Ronald J. Huber, Dubuque, IA (US)

(21) Appl. No.: 15/339,129

(22) Filed: Oct. 31, 2016

(51) Int. Cl. F16H 59/04; F16H 59/02; B60K 20/06

(52) U.S. Cl. CPC F16H 59/044; B60K 20/06; F16H 59/0278

(57) ABSTRACT

A kickdown shift control device for a work vehicle. The work vehicle has a transmission with at least a range and a lower range having more power. The kickdown shift control device comprises a shift switch for switching a travel direction of the work vehicle and for shifting the transmission. The shift switch has a rocker with a forward position, a reverse position, a neutral position, and a kickdown position for shifting the transmission from the range to the lower range. The rocker is positioned in the forward position, the reverse position, and the neutral position with a first force. The rocker is positioned in the kickdown position by pressing the rocker towards the forward position with a second force that is greater than the first force.

### FIELD OF THE DISCLOSURE

The present disclosure generally relates to work vehicles, and more particularly to a system and method for a kickdown shift control device for a work vehicle.

### BACKGROUND OF THE DISCLOSURE

In order to down shift to a lower range to perform a work function and to shift directions between forward, neutral, and reverse, separate control devices are commonly used in work vehicles.

### SUMMARY OF THE DISCLOSURE

In one embodiment, a kickdown shift control device for a work vehicle is disclosed. The work vehicle has a transmission with at least a range and a lower range having more power. The kickdown shift control device comprises a shift switch for switching a travel direction of the work vehicle and for shifting the transmission. The shift switch has a rocker with a forward position for changing the travel direction of the work vehicle to forward, a reverse position for changing the travel direction of the work vehicle to reverse, a neutral position, and a kickdown position for shifting the transmission from the range to the lower range. The rocker is positioned in the forward position by pressing the rocker towards the forward position with a first force. The rocker is positioned in the reverse position by pressing the rocker towards the reverse position with the first force. The rocker is positioned in the neutral position by pressing the rocker towards the neutral position with the first force. The rocker is positioned in the kickdown position by pressing the rocker towards the forward position with a second force that is greater than the first force.

In another embodiment, a work vehicle is disclosed. The work vehicle comprises a transmission with at least a range and a lower range having more power. A kickdown shift control device comprises a shift switch for switching a travel direction of the work vehicle and for shifting the transmission. The shift switch has a rocker with a forward position for changing the travel direction of the work vehicle to forward, a reverse position for changing the travel direction of the work vehicle to reverse, a neutral position, and a kickdown position for shifting the transmission from the range to the lower range. The rocker is positioned in the forward position by pressing the rocker towards the forward position with a first force. The rocker is positioned in the reverse position by pressing the rocker towards the reverse position with the first force. The rocker is positioned in the neutral position by pressing the rocker towards the neutral position with the first force. The rocker is positioned in the kickdown position by pressing the rocker towards the forward position with a second force that is greater than the first force.

In yet another embodiment, a method for controlling a transmission with at least a range and a lower range, the lower range having more power, is disclosed. The method comprises providing a shift switch for switching a travel direction of the work vehicle and for shifting the transmission. The shift switch has a rocker with a forward position for changing the travel direction of the work vehicle to forward, a reverse position for changing the travel direction of the work vehicle to reverse, a neutral position, and a kickdown position for shifting the transmission from the range to the lower range. The method further comprises positioning the rocker in the forward position by pressing the rocker towards the forward position with a first force. The method comprises positioning the rocker in the reverse position by pressing the rocker towards the reverse position with the first force. The method further comprises positioning the rocker in the neutral position by pressing the rocker towards the neutral position with the first force. The method comprises positioning the rocker in the kickdown position by pressing the rocker towards at least one of the forward position and the reverse position with a second force that is greater than the first force.

Other features and aspects will become apparent by consideration of the detailed description and accompanying drawings.

### BRIEF DESCRIPTION OF THE DRAWINGS

FIG. 1 is a perspective view of a wheel loader according to one embodiment.

FIG. 2A is a side view of a kickdown shift control device in a neutral position according to one embodiment.

FIG. 2B is a side view of a kickdown shift control device in a forward position according to the embodiment of FIG. 2A.

FIG. 2C is a side view of a kickdown shift control device in a kickdown position according to the embodiment of FIG. 2A.

FIG. 2D is a side view of a kickdown shift control device in a reverse position according to the embodiment of FIG. 2A.

FIG. 3A is a side view of a kickdown shift control device in a neutral position according to another embodiment.

FIG. 3B is a side view of a kickdown shift control device in a forward position according to the embodiment of FIG. 3A.

FIG. 3C is a side view of a kickdown shift control device in a kickdown position according to the embodiment of FIG. 3A.

FIG. 3D is a side view of a kickdown shift control device in a reverse position according to the embodiment of FIG. 3A.

FIG. 4 is a schematic of an illustrative method for controlling a work vehicle having a transmission with at least a range and a lower range having more power and a kickdown shift control device.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

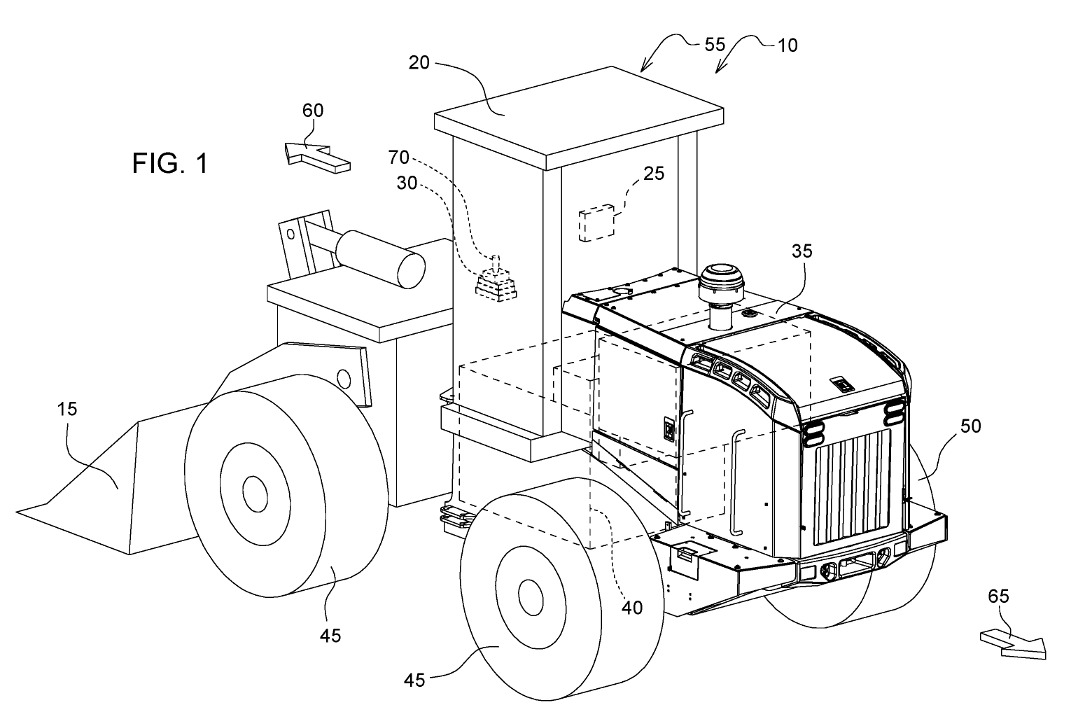

FIG. 1 illustrates a work vehicle 10 having a bucket 15. The work vehicle 15 includes an operator station 20 having an operator interface 25 and a joystick 30. The work vehicle 10 is powered by an engine 35 that is coupled to a transmission 40, having at least a range and a lower range, for transferring power to a pair of left wheels 45 and a pair of right wheels 50. The lower range having more power to accomplish a work task such as driving into a pile. The joystick 30 is in communication with the transmission 40 and is configured to shift the transmission 40 from the range to the lower range. Alternatively, another control may be used to shift the transmission 40 or change direction of the work vehicle 10 (e.g., a steering wheel).

The work vehicle 10 may be any work vehicle 10 that may involve repetitive or temporary downshifting of the transmission 40 such as a wheel loader, a crawler, or an excavator, to name a few examples. For purposes of this disclosure, the term “transmission” can refer to any power-transferring, variable speed device or drivetrain. This can include a transaxle or electric drivetrain machine without a gearbox. Moreover, the term “shift” can refer to a “change in gear ratio”, or a “change in speed ratio”, or simply “more power”, or “more electric current”. In a discrete or fixed ratio transmission, each shift of the transmission results in a shift between a first range having a first gear ratio and a second range having a second gear ratio, where the first and second ratios are different from one another. Alternatively, in a non-discrete transmission, e.g., a continuously-variable transmission, infinitely-variable transmission, etc, movement of the shifter between ranges may result in a shift between a first range corresponding to a first transmission output speed and a second range corresponding to a second transmission output speed, where the first transmission output speed and the second transmission output speed are different from one another. For purposes of this disclosure, the term “range” is intended to refer to a specific speed or gear ratio.

The illustrated work vehicle 10 is a wheel loader 55. The work vehicle 10 may be controlled by an operator located in the operator station 20. Using the joystick 30 and other controls, the operator may command the work vehicle 10 to move forward 60, move backward or reverse 65, and turn. In the case of the work vehicle 10, those commands may be sent to hydraulic pumps, driven by the engine 35, which may direct pressurized hydraulic fluid to hydraulic motors that turn wheels or tracks. The engine 35 may be a diesel engine. Alternatively, the wheels or tracks may be turned by electric motors.

In the illustrated embodiment, a kickdown shift control device 70 is coupled to the joystick 30 and is hand actuated. Alternatively, the kickdown shift control device 70 may be coupled to another control (e.g., steering wheel) that is used to shift the transmission 40 or change direction of the work vehicle 10 and may be foot actuated.

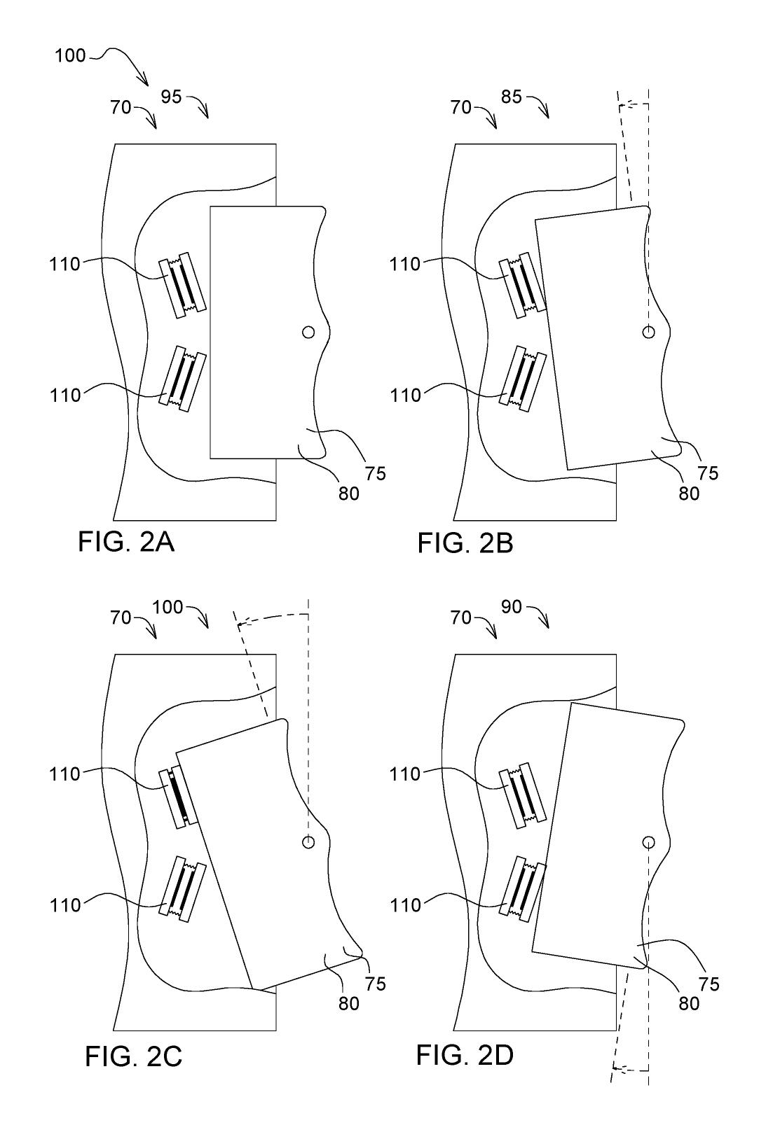

Referring to FIGS. 2A-D and 3A-D, the kickdown shift control device 70 includes a shift switch 75 for switching a travel direction of the work vehicle 10 (FIG. 1) and for shifting the transmission 40 (FIG. 1). The shift switch 75 has a rocker 80 with a forward position 85 (FIGS. 26,36) for changing the travel direction of the work vehicle to forward 60 (FIG. 1). The shift switch 75 has a reverse position 90 (FIGS. 2D,3D) for changing the travel direction of the work vehicle to reverse 65 (FIG. 1). The shift switch 75 also has a neutral position 95 (FIGS. 2A,3A) and a kickdown position 100 (FIGS. 2C,3C) for shifting the transmission 40 from the range to the lower range. The operator interface 25 (FIG. 1) may indicate when the shift switch 75 is in the kickdown position 100 or other position. The indication may be visual (e.g., flashing light on a display), audible (e.g., beep), or via a vibration of the joystick 30 or a seat (not shown), or other indication.

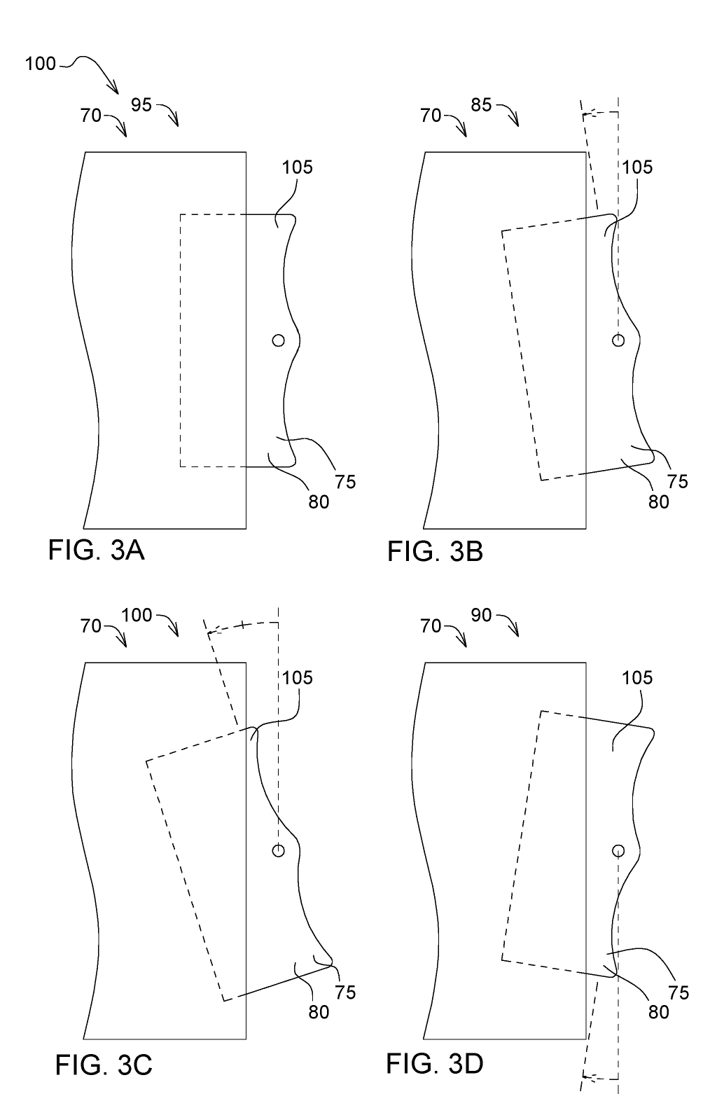

The shift switch 75 may be a five position switch 105 (FIGS. 3A-D) that latches in the forward position 85, the reverse position 90, and the neutral position 95 and is non-latching in the kickdown position 100. Therefore, the shift switch 75 includes five positions that are in order: non-latching (kickdown position 100), latching (forward position 85), latching (neutral position 95), latching (reverse position 90), and non-latching (kickdown position 100). Alternatively, the kickdown shift control device 70 may include a kickdown button 110 (FIGS. 2A-D) for shifting the transmission 40 from the range to the lower range. The rocker 80 may contact the kickdown button 110 by being pressed towards the forward position 85 or the reverse position 90.

The rocker 80 may be positioned in the forward position 85 by pressing the rocker 80 towards the forward position 85 with a first force. The rocker 80 may be positioned in the reverse position 90 by pressing the rocker 80 towards the reverse position 90 with the first force. The rocker 80 may be positioned in the neutral position 95 by pressing the rocker 80 towards the neutral position 95 with the first force. The rocker 80 may be positioned in the kickdown position 100 by pressing the rocker 80 towards the forward position 85 with a second force that is greater than the first force. Alternatively, the rocker 80 may be positioned in the kickdown position 100 by pressing the rocker 80 towards the reverse position 90 with the second force. The first force may be less than thirteen Newtons and the second force may be approximately twenty Newtons. Alternatively, the second force may be at least twice the first force.

Alternatively, the rocker 80 may be positioned in the forward position 85 from the neutral position 95 with the first force. The rocker 80 may be positioned in the reverse position 90 from the neutral position 95 with a third force. The first force and the third force may be approximately thirteen Newtons.

The rocker 80 may be positioned in the neutral position 95 from the forward position 85 with a fourth force. The rocker 80 may be positioned in the neutral position 95 from the reverse position 90 with a fifth force. The fourth force and the fifth force may be approximately eight Newtons.

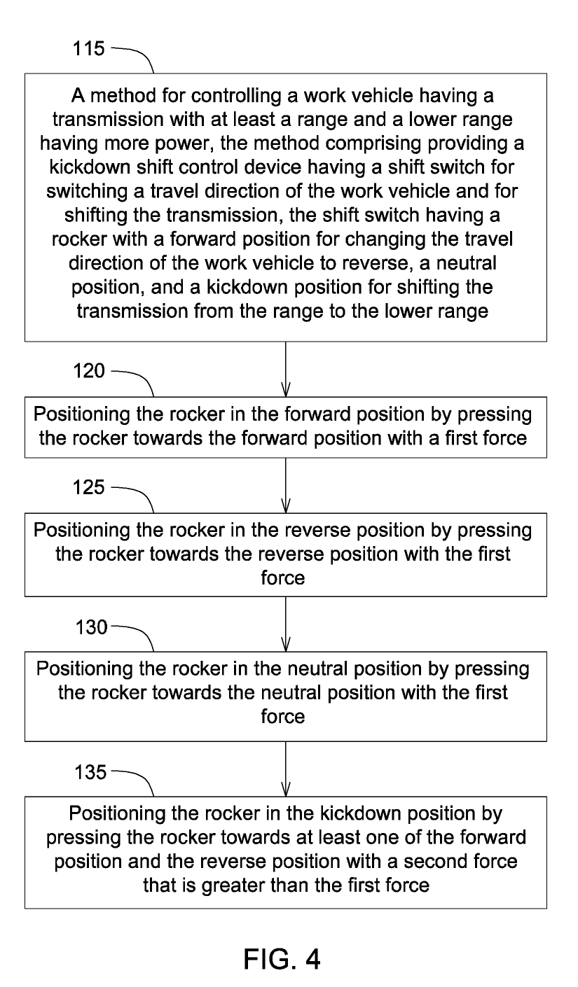

A method for controlling a work vehicle 10 having a transmission 40 with at least a range and a lower range having more power is illustrated in FIG. 4. In Step 115, a kickdown shift control device 70 having a shift switch 75 is provided for switching a travel direction of the work vehicle 10 and for shifting the transmission 40. The shift switch 75 has a rocker 80 with a forward position 85 for changing the travel direction of the work vehicle 10 to forward, a reverse position 90 for changing the travel direction of the work vehicle to reverse, a neutral position 95 for putting the transmission 40 in neutral, and a kickdown position 100 for shifting the transmission 40 from the range to the lower range having more power.

In Step 120 the rocker 80 is positioned in the forward position 85 by pressing the rocker 80 towards the forward position 85 with a first force. In Step 125 the rocker 80 is positioned in the reverse position 90 by pressing the rocker 80 towards the reverse position 90 with the first force.

In Step 130 the rocker 80 is placed in the neutral position 95 by pressing the rocker 80 towards the neutral position 95 with the first force. In Step 135 the rocker 80 is placed in the kickdown position 100 by pressing the rocker 80 towards at least one of the forward position 85 and the reverse position 90 with the second force that is greater than the first force. Alternatively, the rocker 80 may be pressed towards the forward position 85 with the second force so the rocker 80 contacts a kickdown button 110 for shifting the transmission 40 from the range to the lower range. Alternatively, the shift switch 75 may be a five position switch 105 that latches in the forward position 85, the reverse position 90, and the neutral position 95 and is non-latching in the kickdown position 100.

Various features are set forth in the following claims.

What is claimed is:

1. A kickdown shift control device for a work vehicle having a transmission with at least a range and a lower range having more power, the kickdown shift control device comprising:
a shift switch for switching a travel direction of the work vehicle and for shifting the transmission, the shift switch having a rocker with a forward position for changing the travel direction of the work vehicle to forward, a reverse position for changing the travel direction of the work vehicle to reverse, a neutral position, and a kickdown position for shifting the transmission from the range to the lower range;
wherein the rocker is positioned in the forward position by pressing the rocker towards the forward position with a first force, the rocker is positioned in the reverse position by pressing the rocker towards the reverse position with the first force, the rocker is positioned in the neutral position by pressing the rocker towards the neutral position with the first force, and the rocker is positioned in the kickdown position by pressing the rocker towards the forward position with a second force that is greater than the first force.

2. The kickdown shift control device of claim 1, further comprising a kickdown button for shifting the transmission from the range to the lower range.

3. The kickdown shift control device of claim 2, wherein the rocker contacts the kickdown button by pressing the rocker towards the forward position with the second force.

4. The kickdown shift control device of claim 1, wherein the shift switch is a five position switch that latches in the forward position, the reverse position, and the neutral position and is non-latching in the kickdown position.

5. The kickdown shift control device of claim 1, wherein the rocker is positioned in the forward position from the neutral position with the first force, the rocker is positioned in the reverse position from the neutral position with a third force, the rocker is positioned in the neutral position from the forward position with a fourth force, and the rocker is positioned in the neutral position from the reverse position with a fifth force.

6. The kickdown shift control device of claim 5, wherein the first force and the third force are thirteen Newtons, the second force is twenty Newtons, and the fourth force and the fifth force are eight Newtons.

7. The kickdown shift control device of claim 1, wherein the second force is at least twice the first force.

8. The kickdown shift control device of claim 1, further comprising an operator interface that indicates when the shift switch is in the kickdown position.

9. The kickdown shift control device of claim 1, wherein the kickdown shift control device is coupled to a joystick and is hand actuated.

10. The kickdown shift control device of claim 1, wherein the rocker is positioned in the kickdown position by pressing the rocker towards the reverse position with the second force.

11. A work vehicle comprising:
a transmission with at least a range and a lower range having more power; and
a kickdown shift control device comprising:
a shift switch for switching a travel direction of the work vehicle and for shifting the transmission, the shift switch having a rocker with a forward position for changing the travel direction of the work vehicle to forward, a reverse position for changing the travel direction of the work vehicle to reverse, a neutral position, and a kickdown position for shifting the transmission from the range to the lower range;
wherein the rocker is positioned in the forward position by pressing the rocker towards the forward position with a first force, the rocker is positioned in the reverse position by pressing the rocker towards the reverse position with the first force, the rocker is positioned in the neutral position by pressing the rocker towards the neutral position with the first force, and the rocker is positioned in the kickdown position by pressing the rocker towards the forward position with a second force that is greater than the first force.

12. The work vehicle of claim 11, wherein the kickdown shift control device is coupled to a joystick and is hand actuated.

13. The work vehicle of claim 11, wherein the rocker is positioned in the kickdown position by pressing the rocker towards the reverse position with the second force.

14. The work vehicle of claim 11, further comprising a kickdown button for shifting the transmission from the range to the lower range.

15. The work vehicle of claim 14, wherein the rocker contacts the kickdown button by pressing the rocker towards the forward position with the second force.

16. The work vehicle of claim 11, wherein the shift switch is a five position switch that latches in the forward position, the reverse position, and the neutral position and is non-latching in the kickdown position.

17. The work vehicle of claim 11, wherein the rocker is positioned in the forward position from the neutral position with a first force, the rocker is positioned in the reverse position from the neutral position with a third force, the rocker is positioned in the neutral position from the forward position with a fourth force, and the rocker is positioned in the neutral position from the reverse position with a fifth force.

18. A method for controlling a work vehicle having a transmission with at least a range and a lower range having more power, the method comprising:
providing a kickdown shift control device having a shift switch for switching a travel direction of the work vehicle and for shifting the transmission, the shift switch having a rocker with a forward position for changing the travel direction of the work vehicle to forward, a reverse position for changing the travel direction of the work vehicle to reverse, a neutral position, and a kickdown position for shifting the transmission from the range to the lower range;
positioning the rocker in the forward position by pressing the rocker towards the forward position with a first force;
positioning the rocker in the reverse position by pressing the rocker towards the reverse position with the first force;
positioning the rocker in the neutral position by pressing the rocker towards the neutral position with the first force; and
positioning the rocker in the kickdown position by pressing the rocker towards at least one of the forward position and the reverse position with a second force that is greater than the first force.

19. The method of claim 18, further comprising pressing the rocker towards the forward position with the second force so the rocker contacts a kickdown button for shifting the transmission from the range to the lower range.

20. The method of claim 18, wherein the shift switch is a five position switch that latches in the forward position, the reverse position, and the neutral position and is non-latching in the kickdown position.
